(19) United States
(12) Patent Application Publication
(10) Pub. No.: US 2008/0188972 A1
(43) Pub. Date: Aug. 7, 2008

(54) Method and System for Detecting Faults in a Process Plant

(75) Inventor: John P. Miller, Eden Prairie, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER-ROSEMOUNT SYSTEMS, INC., Austin, TX (US)

(21) Appl. No.: 11/548,590

(22) Filed: Oct. 11, 2006

(51) Int. Cl. G06F 17/00

(52) U.S. Cl. 700/110

(57) ABSTRACT

In methods and systems that may facilitate detecting abnormal operation in a process plant, values of a plurality of process variables may be analyzed to determine whether any of a plurality of faults associated with the process plant exist. If one or more faults are detected, one or more indicators may be generated. Analyzing the values of the plurality of process variables may include utilizing a coefficient matrix. The coefficient matrix may be generated based on process variable data corresponding to the known occurrences of faults.

### TECHNICAL FIELD

This disclosure relates generally to process control systems and, more particularly, to techniques for monitoring systems in a process plant.

### DESCRIPTION OF THE RELATED ART

Process control systems, such as distributed or scalable process control systems like those used in chemical, petroleum or other processes, typically include one or more process controllers communicatively coupled to each other, to at least one host or operator workstation and to one or more field devices via analog, digital or combined analog/digital buses. The field devices, which may be, for example valves, valve positioners, switches and transmitters (e.g., temperature, pressure and flow rate sensors), perform functions within the process such as opening or closing valves and measuring process parameters. The process controller receives signals indicative of process measurements made by the field devices and/or other of information pertaining to the field devices, uses this information to implement a control routine and then generates control signals which are sent over the buses to the field devices to control the operation of the process. Information from the field devices and the controller is typically made available to one or more applications executed by the operator workstation to enable an operator to perform any desired function with respect to the process, such as viewing the current state of the process, modifying the operation of the process, etc.

In the past, conventional field devices were used to send and receive analog (e.g., 4 to 20 milliamps) signals to and from the process controller via an analog bus or analog lines. These 4 to 20 mA signals were limited in nature in that they were indicative of measurements made by the device or of control signals generated by the controller required to control the operation of the device. However, in the past decade or so, smart field devices including a microprocessor and a memory have become prevalent in the process control industry. In addition to performing a primary function within the process, smart field devices store data pertaining to the device, communicate with the controller and/or other devices in a digital or combined digital and analog format, and perform secondary tasks such as self calibration, identification, diagnostics, etc. A number of standard and open smart device communication protocols such as the HART®, PROFIBUS®, WORLDFIP®, Device Net®, and CAN protocols, have been developed to enable smart field devices made by different manufacturers to be used together within the same process control network. Moreover, the all digital, two wire bus protocol promulgated by the Fieldbus Foundation, known as the FOUNDATION™ Fieldbus (hereinafter “Fieldbus”) protocol uses function blocks located in different field devices to perform control operations previously performed within a centralized controller. In this case, the Fieldbus field devices are capable of storing and executing one or more function blocks, each of which receives inputs from and/or provides outputs to other function blocks (either within the same device or within different devices), and performs some process control operation, such as measuring or detecting a process parameter, controlling a device or performing a control operation, like implementing a proportional-integral-derivative (PID) control routine. The different function blocks within a process control system are configured to communicate with each other (e.g., over a bus) to form one or more process control loops, the individual operations of which are spread throughout the process and are, thus, decentralized.

Information from the field devices and the process controllers is typically made available to one or more other hardware devices such as operator workstations, maintenance workstations, personal computers, handheld devices, data historians, report generators, centralized databases, etc., to enable an operator or a maintenance person to perform desired functions with respect to the process such as, for example, changing settings of the process control routine, modifying the operation of the control modules within the process controllers or the smart field devices, viewing the current state of the process or of particular devices within the process plant, viewing alarms generated by field devices and process controllers, simulating the operation of the process for the purpose of training personnel or testing the process control software, diagnosing problems or hardware failures within the process plant, etc.

While a typical process plant has many process control and instrumentation devices such as valves, transmitters, sensors, etc. connected to one or more process controllers, there are many other supporting devices that are also necessary for or related to process operation. These additional devices include, for example, power supply equipment, power generation and distribution equipment, rotating equipment such as turbines, motors, etc., which are located at numerous places in a typical plant. While this additional equipment does not necessarily create or use process variables and, in many instances, is not controlled or even coupled to a process controller for the purpose of affecting the process operation, this equipment is nevertheless important to, and ultimately necessary for proper operation of the process.

As is known, problems frequently arise within a process plant environment, especially a process plant having a large number of field devices and supporting equipment. These problems may take the form of broken or malfunctioning devices, logic elements, such as software routines, being in improper modes, process control loops being improperly tuned, one or more failures in communications between devices within the process plant, etc. These and other problems, while numerous in nature, generally result in the process operating in an abnormal state (i.e., the process plant being in an abnormal situation) which is usually associated with suboptimal performance of the process plant. Many diagnostic tools and applications have been developed to detect and determine the cause of problems within a process plant and to assist an operator or a maintenance person to diagnose and correct the problems, once the problems have occurred and been detected. For example, operator workstations, which are typically connected to the process controllers through communication connections such as a direct or wireless bus, Ethernet, modem, phone line, and the like, have processors and memories that are adapted to run software or firmware, such as the DeltaV™ and Ovation control systems, sold by Emerson Process Management which includes numerous control module and control loop diagnostic tools. Likewise, maintenance workstations, which may be connected to the process control devices, such as field devices, via the same communication connections as the controller applications, or via different communication connections, such as OPC connections, handheld connections, etc., typically include one or more applications designed to view maintenance alarms and alerts generated by field devices within the process plant, to test devices within the process plant and to perform maintenance activities on the field devices and other devices within the process plant. Similar diagnostic applications have been developed to diagnose problems within the supporting equipment within the process plant.

Thus, for example, the AMS™ Suite: Intelligent Device Manager application (at least partially disclosed in U.S. Pat. No. 5,960,214 entitled “Integrated Communication Network for use in a Field Device Management System”) sold by Emerson Process Management, enables communication with and stores data pertaining to field devices to ascertain and track the operating state of the field devices. In some instances, the AMS™ application may be used to communicate with a field device to change parameters within the field device, to cause the field device to run applications on itself such as, for example, self-calibration routines or self-diagnostic routines, to obtain information about the status or health of the field device, etc. This information may include, for example, status information (e.g., whether an alarm or other similar event has occurred), device configuration information (e.g., the manner in which the field device is currently or may be configured and the type of measuring units used by the field device), device parameters (e.g., the field device range values and other parameters), etc. Of course, this information may be used by a maintenance person to monitor, maintain, and/or diagnose problems with field devices.

Similarly, many process plants include equipment monitoring and diagnostic applications such as, for example, RBMware provided by CSI Systems, or any other known applications used to monitor, diagnose, and optimize the operating state of various rotating equipment. Maintenance personnel usually use these applications to maintain and oversee the performance of rotating equipment in the plant, to determine problems with the rotating equipment, and to determine when and if the rotating equipment must be repaired or replaced. Similarly, many process plants include power control and diagnostic applications such as those provided by, for example, the Liebert and ASCO companies, to control and maintain the power generation and distribution equipment. It is also known to run control optimization applications such as, for example, real-time optimizers (RTO+), within a process plant to optimize the control activities of the process plant. Such optimization applications typically use complex algorithms and/or models of the process plant to predict how inputs may be changed to optimize operation of the process plant with respect to some desired optimization variable such as, for example, profit.

These and other diagnostic and optimization applications are typically implemented on a system-wide basis in one or more of the operator or maintenance workstations, and may provide preconfigured displays to the operator or maintenance personnel regarding the operating state of the process plant, or the devices and equipment within the process plant. Typical displays include alarming displays that receive alarms generated by the process controllers or other devices within the process plant, control displays indicating the operating state of the process controllers and other devices within the process plant, maintenance displays indicating the operating state of the devices within the process plant, etc. Likewise, these and other diagnostic applications may enable an operator or a maintenance person to retune a control loop or to reset other control parameters, to run a test on one or more field devices to determine the current status of those field devices, to calibrate field devices or other equipment, or to perform other problem detection and correction activities on devices and equipment within the process plant.

While these various applications and tools are very helpful in identifying and correcting problems within a process plant, these diagnostic applications are generally configured to be used only after a problem has already occurred within a process plant and, therefore, after an abnormal situation already exists within the plant. Unfortunately, an abnormal situation may exist for some time before it is detected, identified and corrected using these tools, resulting in the suboptimal performance of the process plant for the period of time during which the problem is detected, identified and corrected. In many cases, a control operator will first detect that some problem exists based on alarms, alerts or poor performance of the process plant. The operator will then notify the maintenance personnel of the potential problem. The maintenance personnel may or may not detect an actual problem and may need further prompting before actually running tests or other diagnostic applications, or performing other activities needed to identify the actual problem. Once the problem is identified, the maintenance personnel may need to order parts and schedule a maintenance procedure, all of which may result in a significant period of time between the occurrence of a problem and the correction of that problem, during which time the process plant runs in an abnormal situation generally associated with the sub-optimal operation of the plant.

Additionally, many process plants can experience an abnormal situation which results in significant costs or damage within the plant in a relatively short amount of time. For example, some abnormal situations can cause significant damage to equipment, the loss of raw materials, or significant unexpected downtime within the process plant if these abnormal situations exist for even a short amount of time. Thus, merely detecting a problem within the plant after the problem has occurred, no matter how quickly the problem is corrected, may still result in significant loss or damage within the process plant. As a result, it is desirable to try to prevent abnormal situations from arising in the first place, instead of simply trying to react to and correct problems within the process plant after an abnormal situation arises.

One technique that may be used to collect data that enables a user to predict the occurrence of certain abnormal situations within a process plant before these abnormal situations actually arise, with the purpose of taking steps to prevent the predicted abnormal situation before any significant loss within the process plant takes place. This procedure is disclosed in U.S. patent application Ser. No. 09/972,078, entitled “Root Cause Diagnostics” (based in part on U.S. patent application Ser. No. 08/623,569, now U.S. Pat. No. 6,017,143). The entire disclosures of both of these applications are hereby incorporated by reference herein. Generally speaking, this technique places statistical data collection and processing blocks or statistical processing monitoring (SPM) blocks, in each of a number of devices, such as field devices, within a process plant. The statistical data collection and processing blocks collect, for example, process variable data and determine certain statistical measures associated with the collected data, such as a mean, a median, a standard deviation, etc. These statistical measures may then be sent to a user and analyzed to recognize patterns suggesting the future occurrence of a known abnormal situation. Once a particular suspected future abnormal situation is detected, steps may be taken to correct the underlying problem, thereby avoiding the abnormal situation in the first place.

Other techniques have been developed to monitor and detect problems in a process plant. One such technique is referred to as Statistical Process Control (SPC). SPC has been used to monitor variables, such as quality variables, associated with a process and flag an operator when the quality variable is detected to have moved from its “statistical” norm. With SPC, a small sample of a variable, such as a key quality variable, is used to generate statistical data for the small sample. The statistical data for the small sample is then compared to statistical data corresponding to a much larger sample of the variable. The variable may be generated by a laboratory or analyzer, or retrieved from a data historian. SPC alarms are generated when the small sample's average or standard deviation deviates from the large sample's average or standard deviation, respectively, by some predetermined amount. An intent of SPC is to avoid making process adjustments based on normal statistical variation of the small samples. Charts of the average or standard deviation of the small samples may be displayed to the operator on a console separate from a control console.

Another technique analyzes multiple variables and is referred to as multivariable statistical process control (MSPC). This technique uses algorithms such as principal component analysis (PCA) and projections to latent structures (PLS) which analyze historical data to create a statistical model of the process. In particular, samples of variables corresponding to normal operation and samples of variables corresponding to abnormal operation are analyzed to generate a model to determine when an alarm should be generated. Once the model has been defined, variables corresponding to a current process may be provided to the model, which may generate an alarm if the variables indicate an abnormal operation.

With model-based performance monitoring system techniques, a model is utilized, such as a correlation-based model or a first-principles model, that relates process inputs to process outputs. The model may be calibrated to the actual plant operation by adjusting internal tuning constants or bias terms. The model can be used to predict when the process is moving into an abnormal region and alert the operator to take action. An alarm may be generated when there is a significant deviation in actual versus predicted behavior or when there is a big change in a calculated efficiency parameter. Model-based performance monitoring systems typically cover as small as a single unit operation (e.g. a pump, a compressor, a heater, a column, etc.) or a combination of operations that make up a process unit (e.g. crude unit, fluid catalytic cracking unit (FCCU), reformer, etc.)

### SUMMARY OF THE DISCLOSURE

Example methods and systems are disclosed that may facilitate detecting abnormal operation in a process plant. Generally speaking, values of a plurality of process variables may be analyzed to determine whether any of a plurality of faults associated with the process plant exist. If one or more faults are detected, one or more indicators may be generated. Analyzing the values of the plurality of process variables may include utilizing a coefficient matrix. The coefficient matrix may be generated based on process variable data corresponding to the occurrences of faults. For example, the coefficient matrix may be generated using process variable data generated by a simulation system or a model that may simulate or model the occurrences of faults. Of course, the coefficient matrix may also be generated with actual process variable data rather than data generated by a simulation system or a model.

In one embodiment, a method for facilitating detection of abnormal operation of a process in a process plant includes receiving process variable data. The process variable data and a coefficient matrix may be utilized to generate a fault observation vector. The fault observation vector may be used to determine if there is abnormal operation of the process.

In another embodiment, a system for facilitating detection of abnormal operation of a process in a process plant may include a fault observation vector generator that receives a coefficient matrix and process variable data. The system may also include an abnormal operation detection system, coupled to the fault observation vector generator. The abnormal operation detection system may detect abnormal operation of the process plant based on a fault observation vector generated by the fault observation vector generator.

In another aspect, a method for configuring an abnormal operation detection system for a process plant includes receiving process variable data corresponding to the occurrences of faults of a process system. A process variable data matrix may be generated based on the first process variable data. Also, a fault matrix corresponding to the process variable data matrix may be generated. Additionally, a coefficient matrix may be generated using the process variable data matrix and the fault matrix. The coefficient matrix may then be used by an abnormal operation detection system to generate indicators of faults based on process variable data received by the abnormal operation detection system.

In another embodiment, a system for facilitating detection of abnormal operation of a process in a process plant comprises at least one computer readable medium and at least one processor coupled to the at least one computer readable medium. The processor may be configured according to executable instructions stored on the at least one computer readable medium to generate a coefficient matrix using a process variable data matrix and a fault matrix. The coefficient matrix may be used by an abnormal operation detection system to generate indicators of faults based on process variable data received by the abnormal operation detection system.

### BRIEF DESCRIPTION OF THE DRAWINGS

FIG. 1 is a block diagram of an example process plant having a distributed control and maintenance network including one or more operator and maintenance workstations, controllers, field devices and supporting equipment;

FIG. 2 is a block diagram of a portion of the process plant of FIG. 1, illustrating communication interconnections between various components of an abnormal situation prevention system located within different elements of the process plant;

FIG. 3 is a block diagram of an example abnormal operation detection (AOD) system that may determine whether one or more faults exist in a process plant;

FIG. 4 is a flow diagram of an example method for determining whether one or more faults exist in a process plant;

FIG. 5 is a flow diagram of an example method of operation of the coefficient matrix generator of FIG. 3;

FIG. 6 is a flow diagram of an example method of operation of the fault observation vector generator and the fault detector of FIG. 3;

FIG. 7 is a block diagram of an example process control system with which an AOD system, such as the AOD system of FIG. 3, may be utilized;

FIG. 8 is a block diagram of an example implementation of an AOD system, such as the AOD system of FIG. 3, in a Fieldbus system;

FIG. 9 is a depiction of an interface device connected within a further process plant to facilitate implementation of one or more AOD systems; and

FIG. 10 is a depiction of an interface device connected within still another process plant to facilitate implementation of one or more AOD systems.

### DETAILED DESCRIPTION

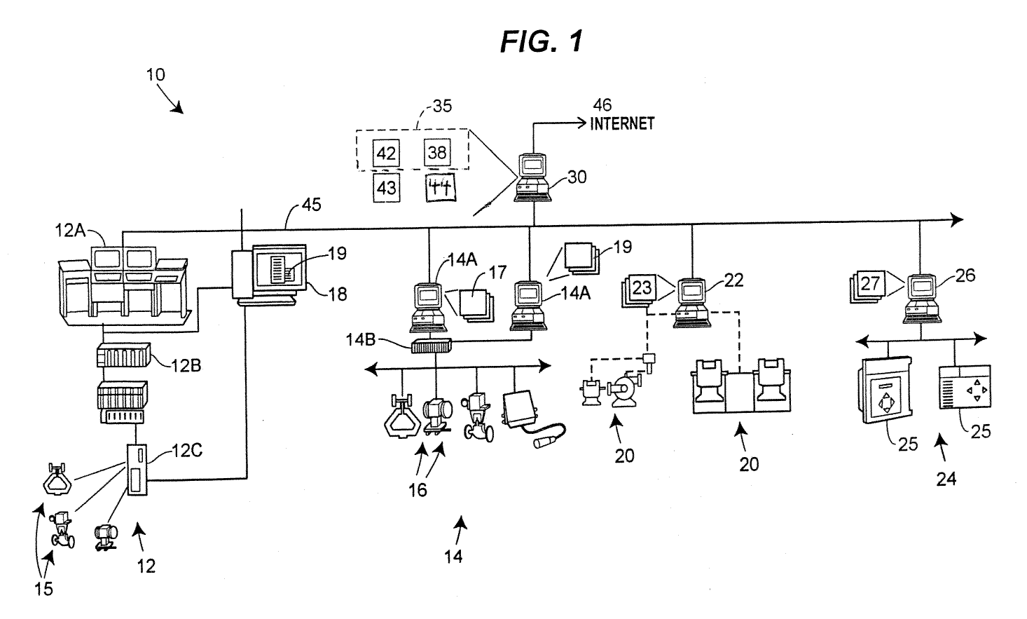

Referring now to FIG. 1, an example process plant 10 in which an abnormal situation prevention system may be implemented includes a number of control and maintenance systems interconnected together with supporting equipment via one or more communication networks. In particular, the process plant 10 of FIG. 1 includes one or more process control systems 12 and 14. The process control system 12 may be a traditional process control system such as a PROVOX or RS3 system or any other control system which includes an operator interface 12A coupled to a controller 12B and to input/output (I/O) cards 12C which, in turn, are coupled to various field devices such as analog and Highway Addressable Remote Transmitter (HART) field devices 15. The process control system 14, which may be a distributed process control system, includes one or more operator interfaces 14A coupled to one or more distributed controllers 14B via a bus, such as an Ethernet bus. The controllers 14B may be, for example, DeltaV™ controllers sold by Emerson Process Management of Austin, Tex. or any other desired type of controllers. The controllers 14B are connected via I/O devices to one or more field devices 16, such as for example, HART or Fieldbus field devices or any other smart or non-smart field devices including, for example, those that use any of the PROFIBUS®, WORLDFIP®, Device-Net®, AS-Interface and CAN protocols. As is known, the field devices 16 may provide analog or digital information to the controllers 14B related to process variables as well as to other device information. The operator interfaces 14A may store and execute tools 17, 19 available to the process control operator for controlling the operation of the process including, for example, control optimizers, diagnostic experts, neural networks, tuners, etc.

Still further, maintenance systems, such as computers executing the AMS™ Suite: Intelligent Device Manager application or any other device monitoring and communication applications may be connected to the process control systems 12 and 14 or to the individual devices therein to perform maintenance and monitoring activities. For example, a maintenance computer 18 may be connected to the controller 12B and/or to the devices 15 via any desired communication lines or networks (including wireless or handheld device networks) to communicate with and, in some instances, reconfigure or perform other maintenance activities on the devices 15. Similarly, maintenance applications such as the AMS application may be installed in and executed by one or more of the user interfaces 14A associated with the distributed process control system 14 to perform maintenance and monitoring functions, including data collection related to the operating status of the devices 16.

The process plant 10 also includes various rotating equipment 20, such as turbines, motors, etc. which are connected to a maintenance computer 22 via some permanent or temporary communication link (such as a bus, a wireless communication system or hand held devices which are connected to the equipment 20 to take readings and are then removed). The maintenance computer 22 may store and execute known monitoring and diagnostic applications 23 provided by, for example, CSI (an Emerson Process Management Company) or other any other known applications used to diagnose, monitor and optimize the operating state of the rotating equipment 20. Maintenance personnel usually use the applications 23 to maintain and oversee the performance of rotating equipment 20 in the plant 10, to determine problems with the rotating equipment 20 and to determine when and if the rotating equipment 20 must be repaired or replaced. In some cases, outside consultants or service organizations may temporarily acquire or measure data pertaining to the equipment 20 and use this data to perform analyses for the equipment 20 to detect problems, poor performance or other issues effecting the equipment 20. In these cases, the computers running the analyses may not be connected to the rest of the system 10 via any communication line or may be connected only temporarily.

Similarly, a power generation and distribution system 24 having power generating and distribution equipment 25 associated with the plant 10 is connected via, for example, a bus, to another computer 26 which runs and oversees the operation of the power generating and distribution equipment 25 within the plant 10. The computer 26 may execute known power control and diagnostics applications 27 such as those provided by, for example, Liebert and ASCO or other companies to control and maintain the power generation and distribution equipment 25. Again, in many cases, outside consultants or service organizations may use service applications that temporarily acquire or measure data pertaining to the equipment 25 and use this data to perform analyses for the equipment 25 to detect problems, poor performance or other issues effecting the equipment 25. In these cases, the computers (such as the computer 26) running the analyses may not be connected to the rest of the system 10 via any communication line or may be connected only temporarily.

As illustrated in FIG. 1, a computer system 30 implements at least a portion of an abnormal situation prevention system 35, and in particular, the computer system 30 stores and implements a configuration application 38 and, optionally, an abnormal operation detection system 42, which will be described in more detail below. Additionally, the computer system 30 may implement an alert/alarm application 43. Further, the computer system 30 may implement a simulation system 44 that may be used to simulate one or more systems in the process plant 10.

Generally speaking, the abnormal situation prevention system 35 may communicate with abnormal operation detection systems (not shown in FIG. 1) optionally located in the field devices 15, 16, the controllers 12B, 14B, the rotating equipment 20 or its supporting computer 22, the power generation equipment 25 or its supporting computer 26, and any other desired devices and equipment within the process plant 10, and/or the abnormal operation detection system 42 in the computer system 30, to configure each of these abnormal operation detection systems and to receive information regarding the operation of the devices or subsystems that they are monitoring. The abnormal situation prevention system 35 may be communicatively connected via a hardwired bus 45 to each of at least some of the computers or devices within the plant 10 or, alternatively, may be connected via any other desired communication connection including, for example, wireless connections, dedicated connections which use OPC, intermittent connections, such as ones which rely on handheld devices to collect data, etc. Likewise, the abnormal situation prevention system 35 may obtain data pertaining to the field devices and equipment within the process plant 10 via a LAN or a public connection, such as the Internet, a telephone connection, etc. (illustrated in FIG. 1 as an Internet connection 46) with such data being collected by, for example, a third party service provider. Further, the abnormal situation prevention system 35 may be communicatively coupled to computers/devices in the plant 10 via a variety of techniques and/or protocols including, for example, Ethernet, Modbus, HTML, XML, proprietary techniques/protocols, etc. Thus, although particular examples using OPC to communicatively couple the abnormal situation prevention system 35 to computers/devices in the plant 10 are described herein, one of ordinary skill in the art will recognize that a variety of other methods of coupling the abnormal situation prevention system 35 to computers/devices in the plant 10 can be used as well.

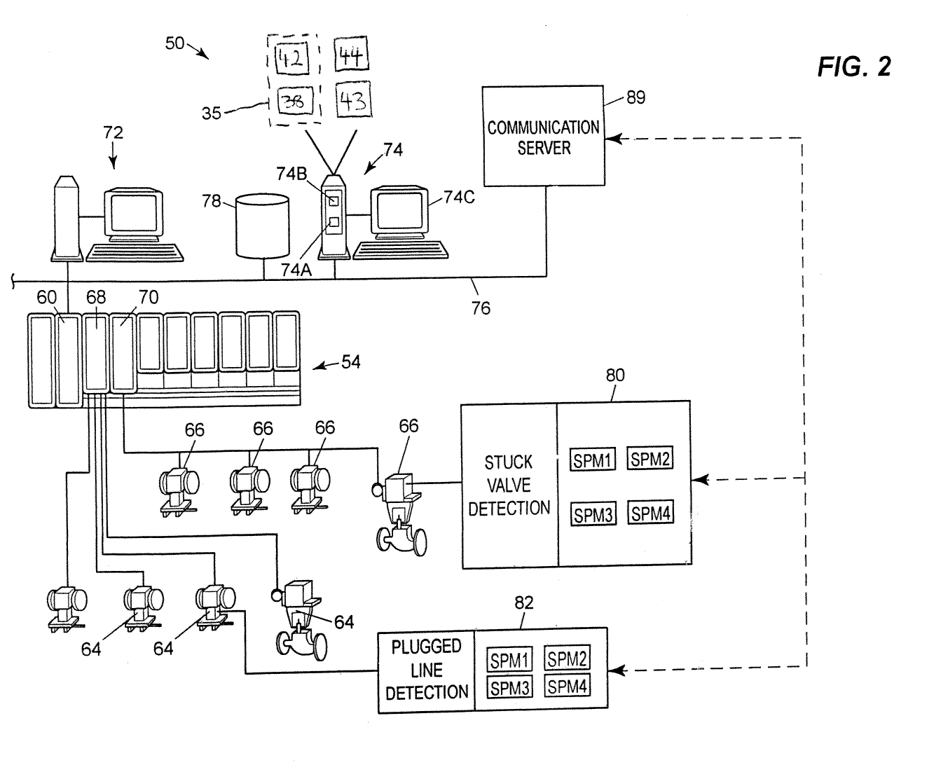

FIG. 2 illustrates a portion 50 of the example process plant 10 of FIG. 1 for the purpose of describing one manner in which the abnormal situation prevention system 35 and/or the alert/alarm application 43 may communicate with various devices in the portion 50 of the example process plant 10. While FIG. 2 illustrates communications between the abnormal situation prevention system 35 and one or more abnormal operation detection systems within HART and Fieldbus field devices, it will be understood that similar communications can occur between the abnormal situation prevention system 35 and other devices and equipment within the process plant 10, including any of the devices and equipment illustrated in FIG. 1.

The portion 50 of the process plant 10 illustrated in FIG. 2 includes a distributed process control system 54 having one or more process controllers 60 connected to one or more field devices 64 and 66 via input/output (I/O) cards or devices 68 and 70, which may be any desired types of I/O devices conforming to any desired communication or controller protocol. The field devices 64 are illustrated as HART field devices and the field devices 66 are illustrated as Fieldbus field devices, although these field devices could use any other desired communication protocols. Additionally, each of the field devices 64 and 66 may be any type of device such as, for example, a sensor, a valve, a transmitter, a positioner, etc., and may conform to any desired open, proprietary or other communication or programming protocol, it being understood that the I/O devices 68 and 70 must be compatible with the desired protocol used by the field devices 64 and 66.

In any event, one or more user interfaces or computers 72 and 74 (which may be any types of personal computers, workstations, etc.) accessible by plant personnel such as configuration engineers, process control operators, maintenance personnel, plant managers, supervisors, etc. are coupled to the process controllers 60 via a communication line or bus 76 which may be implemented using any desired hardwired or wireless communication structure, and using any desired or suitable communication protocol such as, for example, an Ethernet protocol. In addition, a database 78 may be connected to the communication bus 76 to operate as a data historian that collects and stores configuration information as well as on-line process variable data, parameter data, status data, and other data associated with the process controllers 60 and field devices 64 and 66 within the process plant 10. Thus, the database 78 may operate as a configuration database to store the current configuration, including process configuration modules, as well as control configuration information for the process control system 54 as downloaded to and stored within the process controllers 60 and the field devices 64 and 66. Likewise, the database 78 may store historical abnormal situation prevention data, including statistical data collected by the field devices 64 and 66 within the process plant 10, statistical data determined from process variables collected by the field devices 64 and 66, and other types of data that will be described below.

While the process controllers 60, I/O devices 68 and 70, and field devices 64 and 66 are typically located down within and distributed throughout the sometimes harsh plant environment, the workstations 72 and 74, and the database 78 are usually located in control rooms, maintenance rooms or other less harsh environments easily accessible by operators, maintenance personnel, etc.

Generally speaking, the process controllers 60 store and execute one or more controller applications that implement control strategies using a number of different, independently executed, control modules or blocks. The control modules may each be made up of what are commonly referred to as function blocks, wherein each function block is a part or a subroutine of an overall control routine and operates in conjunction with other function blocks (via communications called links) to implement process control loops within the process plant 10. As is well known, function blocks, which may be objects in an object-oriented programming protocol, typically perform one of an input function, such as that associated with a transmitter, a sensor or other process parameter measurement device, a control function, such as that associated with a control routine that performs PID, fuzzy logic, etc. control, or an output function, which controls the operation of some device, such as a valve, to perform some physical function within the process plant 10. Of course, hybrid and other types of complex function blocks exist, such as model predictive controllers (MPCs), optimizers, etc. it is to be understood that while the Fieldbus protocol and the DeltaV™ system protocol use control modules and function blocks designed and implemented in an object-oriented programming protocol, the control modules may be designed using any desired control programming scheme including, for example, sequential function blocks, ladder logic, etc., and are not limited to being designed using function blocks or any other particular programming technique.

As illustrated in FIG. 2, the maintenance workstation 74 includes a processor 74A, a memory 74B and a display device 74C. The memory 74B stores the abnormal situation prevention application 35 and the alert/alarm application 43 discussed with respect to FIG. 1 in a manner that these applications can be implemented on the processor 74A to provide information to a user via the display 74C (or any other display device, such as a printer).

The memory 74B may also store the simulation application 44 discussed with respect to FIG. 1 in a manner that the simulation application 44 can be implemented on the processor 74A.

Each of one or more of the field devices 64 and 66 may include a memory (not shown) for storing routines such as routines for implementing statistical data collection pertaining to one or more process variables sensed by sensing device and/or routines for abnormal operation detection, which will be described below. Each of one or more of the field devices 64 and 66 may also include a processor (not shown) that executes routines such as routines for implementing statistical data collection and/or routines for abnormal operation detection. Statistical data collection and/or abnormal operation detection need not be implemented by software. Rather, one of ordinary skill in the art will recognize that such systems may be implemented by any combination of software, firmware, and/or hardware within one or more field devices and/or other devices.

As shown in FIG. 2, some (and potentially all) of the field devices 64 and 66 include abnormal operation detection blocks 80 and 82, which will be described in more detail below. While the blocks 80 and 82 of FIG. 2 are illustrated as being located in one of the devices 64 and in one of the devices 66, these or similar blocks could be located in any number of the field devices 64 and 66, could be located in other devices, such as the controller 60, the I/O devices 68, 70 or any of the devices illustrated in FIG. 1. Additionally, the blocks 80 and 82 could be in any subset of the devices 64 and 66.

Generally speaking, the blocks 80 and 82 or sub-elements of these blocks, collect data, such a process variable data, from the device in which they are located and/or from other devices. Additionally, the blocks 80 and 82 or sub-elements of these blocks may process the variable data and perform an analysis on the data for any number of reasons. For example, the block 80, which is illustrated as being associated with a valve, may have a stuck valve detection routine which analyzes the valve process variable data to determine if the valve is in a stuck condition. In addition, the block 80 may include a set of one or more statistical process monitoring (SPM) blocks or units such as blocks SPM1-SPM4 which may collect process variable or other data within the valve and perform one or more statistical calculations on the collected data to determine, for example, a mean, a median, a standard deviation, a root-mean-square (RMS), a rate of change, a range, a minimum, a maximum, etc. of the collected data and/or to detect events such as drift, bias, noise, spikes, etc., in the collected data. The specific statistical data generated, nor the method in which it is generated is not critical. Thus, different types of statistical data can be generated in addition to, or instead of, the specific types described above. Additionally, a variety of techniques, including known techniques, can be used to generate such data. The term statistical process monitoring (SPM) block is used herein to describe functionality that performs statistical process monitoring on at least one process variable or other process parameter, and may be performed by any desired software, firmware or hardware within the device or even outside of a device for which data is collected. It will be understood that, because the SPMs are generally located in the devices where the device data is collected, the SPMs can acquire quantitatively more and qualitatively more accurate process variable data. As a result, the SPM blocks are generally capable of determining better statistical calculations with respect to the collected process variable data than a block located outside of the device in which the process variable data is collected.

It is to be understood that although the blocks 80 and 82 are shown to include SPM blocks in FIG. 2, the SPM blocks may instead be stand-alone blocks separate from the blocks 80 and 82, and may be located in the same device as the corresponding block 80 or 82 or may be in a different device. The SPM blocks discussed herein may comprise known Foundation Fieldbus SPM blocks, or SPM blocks that have different or additional capabilities as compared with known Foundation Fieldbus SPM blocks. The term statistical process monitoring (SPM) block is used herein to refer to any type of block or element that collects data, such as process variable data, and performs some statistical processing on this data to determine a statistical measure, such as a mean, a standard deviation, etc. As a result, this term is intended to cover software, firmware, hardware and/or other elements that perform this function, whether these elements are in the form of function blocks, or other types of blocks, programs, routines or elements and whether or not these elements conform to the Foundation Fieldbus protocol, or some other protocol, such as Profibus, HART, CAN, etc. protocol. If desired, the underlying operation of blocks 50 may be performed or implemented at least partially as described in U.S. Pat. No. 6,017,143, which is hereby incorporated by reference herein.

It is to be understood that although the blocks 80 and 82 are shown to include SPM blocks in FIG. 2, SPM blocks are not required of the blocks 80 and 82. For example, abnormal operation detection routines of the blocks 80 and 82 could operate using process variable data not processed by an SPM block. As another example, the blocks 80 and 82 could each receive and operate on data provided by one or more SPM block located in other devices. As yet another example, the process variable data could be processed in a manner that is not provided by many typical SPM blocks. As just one example, the process variable data could be filtered by a finite impulse response (FIR) or infinite impulse response (IIR) filter such as a bandpass filter or some other type of filter. As another example, the process variable data could be trimmed so that it remained in a particular range. Of course, known SPM blocks could be modified to provide such different or additional processing capabilities.

The block 82 of FIG. 2, which is illustrated as being associated with a transmitter, may have a plugged line detection unit that analyzes the process variable data collected by the transmitter to determine if a line within the plant is plugged. In addition, the block 82 may includes one or more SPM blocks or units such as blocks SPM1-SPM4 which may collect process variable or other data within the transmitter and perform one or more statistical calculations on the collected data to determine, for example, a mean, a median, a standard deviation, etc. of the collected data. While the blocks 80 and 82 are illustrated as including four SPM blocks each, the blocks 80 and 82 could have any other number of SPM blocks therein for collecting and determining statistical data.

Overview of an Abnormal Operation Detection (AOD) System

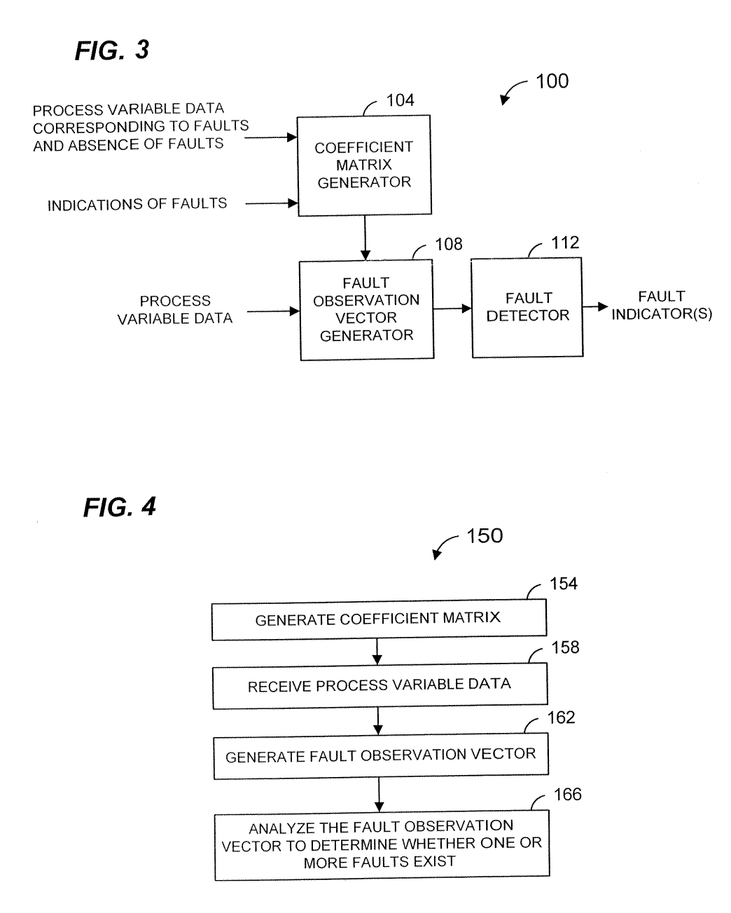

FIG. 3 is a block diagram of example abnormal operation detection (AOD) system 100 that could be utilized in the abnormal operation detection blocks 80 and 82 of FIG. 2. The AOD system 100 may include a coefficient matrix generator 104 coupled to a fault observation vector generator 108. The coefficient matrix generator 104 receives process variable data corresponding to known or assumed occurrences of faults (e.g., abnormal events, abnormal operation, abnormal situations, etc.) in the process plant. Additionally, the coefficient matrix generator 104 receives indications of the faults corresponding to the received process variable data. Generally speaking, the indications of the faults provide information about which of the received process variable data corresponds to which of the faults. The received process variable data may also include data corresponding to the known or assumed absence of all of the faults. The coefficient matrix generator 104 generates a coefficient matrix based on the received information, and, as will be described in more detail subsequently, the coefficient matrix may be applied to process variable data to help determine whether one or more of the faults exist.

As will be discussed in more detail subsequently, the process variable data received by the coefficient matrix generator 104 may comprise data generated by devices in the process plant. For example, data corresponding to known or assumed faults could be retrieved from a data historian. Similarly, data corresponding to the absence of all of the faults could be retrieved from the data historian. Additionally or alternatively, the data may be generated by a model or a simulation application. For example, a simulation application may simulate faults and generate simulated process variable data corresponding to those faults. Similarly, the simulator may generate process variable data corresponding to the absence of all of the faults.

The fault observation vector generator 108 receives the coefficient matrix from the coefficient matrix generator 104 and also receives process variable data. Generally, the fault observation matrix generator 108 applies the coefficient matrix to the received process variable data to generate a fault observation vector.

The AOD system 100 additionally comprises a fault detector 112 coupled to the fault observation vector generator 108. The fault detector 112 receives the fault observation vector from the fault observation vector generator 108 and analyzes the fault observation vector to determine if one or more faults exist. As will be described in more detail subsequently, the fault detector 112 may optionally analyze additional information to determine if the one or more faults exist.

FIG. 4 is a flow diagram of an example method 150 for determining whether one or more faults exist in a process plant. The method 150 may be implemented by the AOD system 100 of FIG. 3, for example, but may also be implemented by other systems as well. At a block 154, a coefficient matrix may be generated using process variable data corresponding to known or assumed occurrences of faults in the process plant, and optionally data corresponding to the known or assumed absence of all of the faults. Generation of the coefficient matrix will be described in more detail subsequently.

At a block 158, process variable data may be received. Then, at a block 162, a fault observation vector may be generated using the received process variable data and the coefficient matrix. Generation of the fault observation vector will be described in more detail subsequently.

Next, at a block 166, the fault observation vector may be analyzed to determine whether one or more faults exist. Optionally, other information may also be analyzed to determine whether one or more of the faults exist.

Generating the Coefficient Matrix

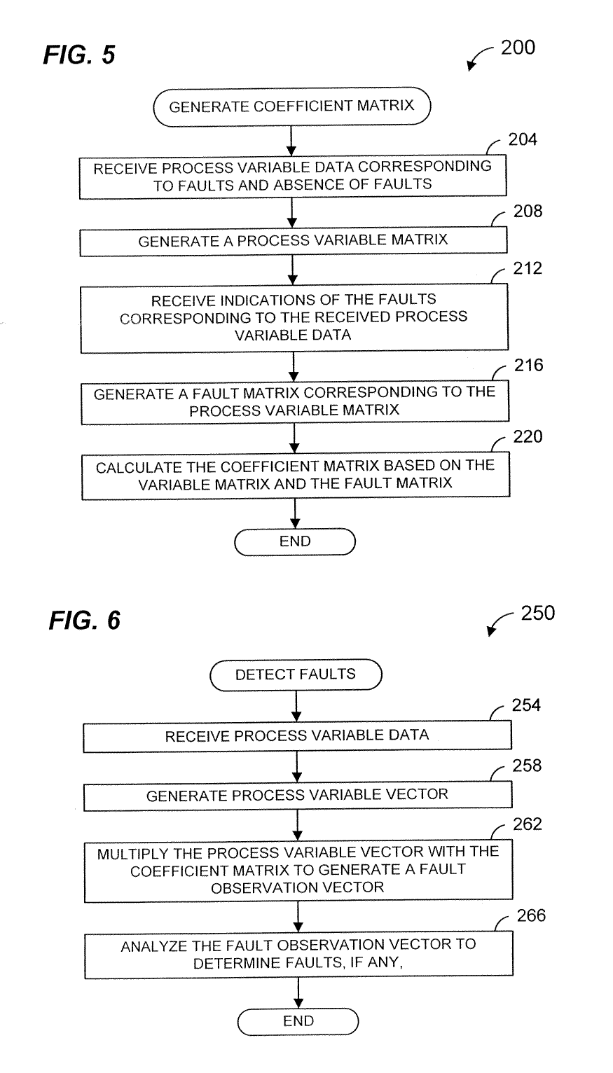

Example methods for generating the coefficient matrix will now be described. Referring now to FIG. 5, an example method 200 for generating the coefficient matrix includes a block 204, at which process variable data corresponding to the existence of fault and the absence of faults may be received. For example, the received process variables may be denoted as x₁, x₂, x₃, . . . x_{M}, where M is the number of process variables. Additionally, these process variables may change over time. Thus, the i^{th} observation of x₁, may be denoted x_{i,1}. Similarly, the i^{th} observation of the group of received process variables may be denoted as a row vector: \vec{x}ᵢ=└x_{i,1} x_{i,2} x_{i,3} . . . x_{i,M}┘. The block 204 may comprise receiving process variable data corresponding to observations 1, 2, 3, . . . , N.

In one implementation, for each fault, one or more of the received observations correspond to the occurrence of the fault in the absence of the other faults. Additionally, one or more of the received observations corresponds to the absence of all of the faults. As a specific example for explanatory purpose, if there are four faults, ten of the observations may correspond to the absence of all faults, twelve of the observations may correspond to the occurrence of the first fault only, eight of the observations may correspond to the occurrence of the second fault only, fifteen of the observations may correspond to the occurrence of the third fault only, and eighteen of the observations may correspond to the occurrence of the fourth fault only. The number of observations corresponding to each of the faults and the absence of faults may be different or they could be the same.

Alternatively, at least some of the observations may correspond to the occurrence of two or more faults. This would be particularly useful if there is any non-linear interaction between two or more faults. Similarly, there may be no observations corresponding to the absence of all faults. But, in general, one of ordinary skill in the art will recognize that there should be enough observations to provide a statistically reliable sample of the process, under each possible fault and non-fault condition, in order to ensure a robust calculation of a coefficient matrix, as will be described below.

At a block 208, a process variable matrix may be generated using the data received at the block 204. For example, if process variable data corresponding to N observations are received, N row vectors \vec{x}₁, \vec{x}₂, \vec{x}₃, . . . , \vec{x}_{N} corresponding to the observations 1, 2, 3, . . . , N can be created, and these vectors can be combined into a matrix X. If there are M process variables, then the size of the matrix X would be N×M. Generating the matrix may comprise, for example, storing the process variable data in particular memory locations, noting the memory locations in which the process variable data is stored, etc.

At a block 212, indications of the faults corresponding to the process variable data received at the block 204 may be received. Then, at a block 216, a fault matrix corresponding to the process variable matrix generated at the block 208 may be generated. There may be P possible faults F₁, F₂, F₃, . . . , F_{P}. In one implementation, a row vector \vec{F}ᵢ[f_{i,1} f_{i,2} f_{i,3} . . . f_{i,P}] may correspond to the i^{th} row of the process variable matrix X generated at the block 208, where each element f_{i,j} is 0 if the fault Fⱼ is not active at observation i, and 1 if the fault is active at this observation. Thus, if no faults are active, we would have \vec{F}ᵢ=[0 0 0 . . . 0], and if only fault F₂ was active, we would have \vec{F}ᵢ=[0 1 0 . . . 0]. The fault vectors \vec{F}ᵢ for all N observations can be put together in a fault matrix F of size N×P, where the i^{th} row of the matrix F corresponds to the i^{th} row of the matrix X. In other words, the i^{th} row of the matrix F indicates which, if any, faults correspond to the process variable data in the i^{th} row of the matrix X.

Next, at a block 220, a coefficient matrix may be generated based on the process variable matrix generated at the block 208 and the fault matrix generated at the block 216. Generally, a coefficient matrix A may be calculated in an attempt to satisfy, at least approximately, the equation:

F=XA (Equ. 1)

Many techniques for solving this equation for A may be utilized. Some techniques may involve regression. For example, in an ordinary least squares (OLS) technique, also known as multiple linear regression (MLR), the matrix A may be calculated as:

A=(X^{T}X)⁻¹X^{T}F (Equ. 2)

where A is a matrix of size M×P.

Many other regression techniques may also be used. For example, regression techniques may be utilized such as partial least squares (PLS), principal component analysis (PCA), principal component regression (PCR), ridge regression (RR), variable subset selection (VSS), support vector machines (SVM), etc. For instance, if there is a high correlation among the process variables, an OLS technique may encounter nearly singular matrices leading to less robust results. On the other hand, PLS techniques may be provide better results ins such situations. Non-linear regression techniques (e.g. higher powers, cross-terms, and non-linear functions of the process variables) may also be used. For example, neural networks may be used for non-linear regression. There may also be a dynamic/time-series component to regression. In such cases, a single process variable x may be augmented by one or more values of the same x, but at different times (e.g. xₖ, xₖ₋₁, xₖ₋₂, etc.)

Additionally, non-regression techniques may be used to solve for A. Such techniques may include, for example, neural networks, as well as stochastic search techniques (e.g. Random search, simulated annealing, genetic algorithm), etc.

In another implementation, at the block 208, generating the process variable matrix may comprise including biasing terms in the matrix. For example, rows of the matrix X could include a leading 1. In other words, the i^{th} row vector may be \vec{x}ᵢ=└1 x_{i,1} x_{i,2} x_{i,3} . . . x_{i,M}┘. In this implementation, the size of the process variable matrix X would be N×(M+1) and the size of the coefficient matrix A would be (M+1)×P.

Utilizing the Coefficient Matrix to Detect Faults

Example methods for detecting faults using the coefficient matrix will now be described. Referring now to FIG. 6, an example method 250 for detecting faults includes a block 254, at which process variable data may be received. For example, the received process variables may be denoted as x_{i,1}, x_{i,2}, x_{i,3}, . . . x_{i,M}, where M is the number of process variables and i indicates the i^{th} observation of the process variables. At a block 258, a process variable vector may be generated using the received process variable data. For example, a row vector \vec{x}ᵢ=└x_{i,1} x_{i,2} x_{i,3} . . . x_{i,M}┘ or a row vector \vec{x}ᵢ=└1 x_{i,1} x_{i,2} x_{i,3} . . . x_{i,M}┘ may be generated.

At a block 262, the process variable vector may be multiplied with the coefficient matrix A to generate a fault observation vector. For example, the fault observation vector may be generated according to the equation:

{circumflex over (\vec{F}ᵢ=\vec{x}ᵢA (Equ. 3)

In this implementation, the fault observation vector {circumflex over (\vec{F}ᵢ will have a size of 1×P and may be denoted as {circumflex over (\vec{F}ᵢ[\hat{f}_{i,1} \hat{f}_{i,2} \hat{f}_{i,3} . . . \hat{f}_{i,P}]. Typically, the components of the fault observation vector {circumflex over (\vec{F}ᵢ will not be merely 0's and 1's unless the components of the process variable vector \vec{x}ᵢ are exactly the same as that of a process variable vector used to generate the matrix A. Thus, the components of the fault observation vectors will be real numbers, typically between 0 and 1, but in some instances may be less than 0 or more than 1. In general, if a component of the fault observation vector is significantly close to 1, this may indicate a fault. Additionally, the components \hat{f}_{i,1}, \hat{f}_{i,2}, \hat{f}_{i,3}, . . . \hat{f}_{i,P} correspond to the different faults. In particular, \hat{f}_{i,1} corresponds to the possible existence of fault F₁, \hat{f}_{i,2} corresponds to the possible existence of fault F₂, etc.

Generating the fault observation vector may optionally be part of generating a fault observation matrix. For example, a plurality of process variable row vectors \vec{x}ᵢ, \vec{x}ᵢ₊₁, \vec{x}ᵢ₊₂, etc., could be assembled into a matrix X. Then, a fault observation matrix \hat{F} could be generated according to the equation:

\hat{F}=XA (Equ. 4)

where the ith row of the fault observation matrix \hat{F} is the fault observation vector {circumflex over (\vec{F}ᵢ=[\hat{f}_{i,1} \hat{f}_{i,2} \hat{f}_{i,3} . . . \hat{f}_{i,P}] corresponding to the ith observation of the process variables, i.e., \vec{x}ᵢ=└x_{i,1} x_{i,2} x_{i,3} . . . x_{i,M}┘ or \vec{x}ᵢ=└1 x_{i,1} x_{i,2} x_{i,3} . . . x_{i,M}┘.

At a block 266, the fault observation vector may be analyzed to determine which, if any, faults exist. This may comprise, for example, determining which if any of the components are significantly close to 1. For example, if the jth component is close to 1, this may indicate that the fault Fⱼ exists. Determining if a component is significantly close to 1 may be implemented using a variety of techniques. For example, it may comprise comparing the component to a threshold that is less than one. The threshold may be a default value, such as 0.8 or some other value, and/or it may be configurable by a process operator, who may use knowledge of the process, experimentation, etc., for example, to set an appropriate value for the threshold.

As another example, determining if a component is significantly close to 1 may comprise analyzing several values of the components at different times. For instance, it may comprise comparing values of a component at times i, i+1, i+2, etc., to a threshold. In this example, if some number of consecutive values exceed the threshold, or if some number of values in a larger set of consecutive values exceeds the threshold, it may be determined that the component is significantly close to 1. Any of a variety of other techniques may alternatively or additionally be used.

Because each component of the fault observation vector corresponds to a different possible fault, determining which components are significantly close to 1 also indicates which faults may exist.

Optionally, other information may be used to determine whether any faults exist. For example, other process variable data, SPM data, alert, alarms, etc., also may be analyzed to determine whether any faults exist. Similarly, the fault observation vector and/or the fault indicators generated by the fault detector 112 (FIG. 3) may be used to detect whether an abnormal situation occurred, is occurring, is likely to occur, etc. For instance, the fault observation vector and/or the fault indicators generated by the fault detector 112 (FIG. 3) may be provided to an expert engine, a neural network system, a fuzzy logic system etc., configured to detect abnormal situations. The expert engine, the neural network system, the fuzzy logic system, etc., may utilize information other than the fault observation vector and/or the fault indicators to detect abnormal situations. For example, other process variable data, SPM data, alert, alarms, etc., also may be utilized.

Referring now to FIGS. 3 and 6, the fault observation vector generator 108 may implement the blocks 254, 258, and 262 for example. Optionally, the blocks 254 and 258 could be implemented elsewhere, and the fault observation vector generator 108 may merely receive the process variable vector and then implement the block 262. The fault detector 112 may implement the block 266, for example.

### ILLUSTRATIVE EXAMPLE

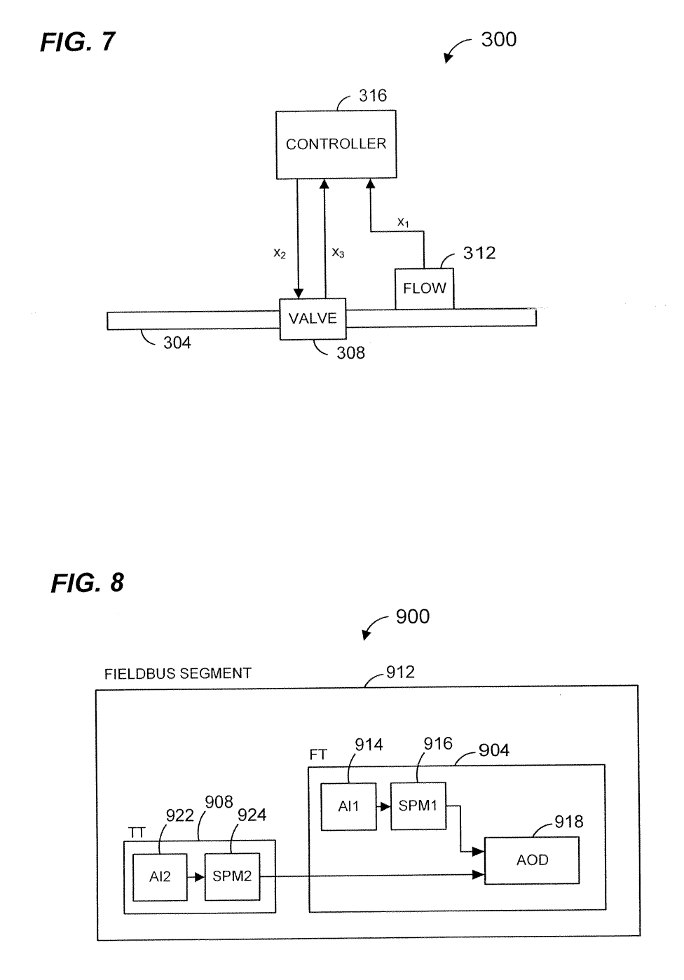

FIG. 7 is an example process control system 300 in which the example systems and methods described above may be utilized. The process control system 300 of FIG. 7 is merely a simple example used to help explain the systems and methods described above. It will be understood by those of ordinary skill in the art that the systems and methods described above can be used with many other process control systems, including much more complex process control systems.

The system 300 includes a flow control loop that controls the flow in a pipe 304. The system includes a valve device 308, a flow sensor 312, and a controller 316. The flow sensor 312 generates a flow rate signal x₁. The valve device 308 generates a valve position signal x₃. The controller 316 receives the flow rate signal x₁, and the valve position signal x₃, and generates a control demand signal x₂ to control the position of the valve. The valve 308 receives the control demand signal x₂ from the controller 316 and then adjusts the position of the valve accordingly. In the example process control system 300, there may be four faults that can occur: F₁, control wound up (CWU); F₂, control wound down (CWD); F₃, valve problem (VP); and F₄, measurement drift (MD).

Data sets of the system 300 could be obtained by observing the system 300 during faultless operation and when each of the four faults occur, for example. In particular, the variables x₁, x₂, and x₃, may be observed during known occurrences of the faults F₁, F₂, F₃, and F₄, as well as when none of the faults occur. Table 1 is an example data set including 138 observations, the observations including observations when none of the faults occurred as well as for each of the four fault conditions. The rightmost column indicates which fault, if any, occurs at each observation.

TABLE 1

| Observation | x₁ | x₂ | x₃ | Fault |
|---|---|---|---|---|
| 1 | 2.412 | 54.432 | 52.123 | |
| 2 | 2.408 | 54.336 | 52.035 | |
| 3 | 2.413 | 54.283 | 51.971 | |
| . . . | . . . | . . . | . . . | . . . |
| 29 | 2.459 | 54.249 | 51.936 | |
| 30 | 2.457 | 54.159 | 51.838 | |
| 31 | 2.448 | 62.134 | 61.333 | MD |
| 32 | 2.451 | 62.143 | 61.432 | MD |
| . . . | . . . | . . . | . . . | . . . |
| 48 | 2.449 | 62.004 | 61.503 | MD |
| 49 | 2.447 | 61.923 | 61.499 | MD |
| 50 | 2.437 | 61.862 | 53.321 | VP |
| 51 | 2.439 | 61.899 | 53.296 | VP |
| 52 | 2.437 | 61.956 | 53.348 | VP |
| . . . | . . . | . . . | . . . | . . . |
| 78 | 2.464 | 61.895 | 53.259 | VP |
| 79 | 2.456 | 61.868 | 53.165 | VP |
| 80 | 2.456 | 61.948 | 53.089 | VP |
| 81 | 2.452 | 99.000 | 99.000 | CWU |
| 82 | 2.462 | 98.949 | 99.045 | CWU |
| 83 | 2.453 | 98.891 | 98.952 | CWU |
| . . . | . . . | . . . | . . . | . . . |
| 107 | 2.467 | 98.678 | 98.894 | CWU |
| 108 | 2.469 | 98.631 | 98.942 | CWU |
| 109 | 2.472 | 1.000 | 2.000 | CWD |
| 110 | 2.473 | 1.058 | 2.009 | CWD |
| 111 | 2.477 | 1.105 | 2.100 | CWD |
| . . . | . . . | . . . | . . . | . . . |
| 137 | 2.483 | 1.268 | 2.162 | CWD |
| 138 | 2.493 | 1.331 | 2.146 | CWD |

Using techniques described above, an X matrix and an F matrix can be generated using the data from Table 1:

$$X = [ \begin{matrix}1 & 2.412 & 54.432 & 52.123 \\ 1 & 2.408 & 54.336 & 52.035 \\ ⋯ & ⋯ & ⋯ & ⋯ \\ 1 & 2.457 & 54.159 & 51.838 \\ 1 & 2.448 & 62.134 & 61.333 \\ 1 & 2.451 & 62.143 & 61.432 \\ ⋯ & ⋯ & ⋯ & ⋯ \\ 1 & 2.447 & 61.923 & 61.499 \\ 1 & 2.437 & 61.862 & 53.321 \\ 1 & 2.439 & 61.899 & 53.296 \\ ⋯ & ⋯ & ⋯ & ⋯ \\ 1 & 2.456 & 61.948 & 53.089 \\ 1 & 2.452 & 99.000 & 99.000 \\ 1 & 2.462 & 98.949 & 99.045 \\ ⋯ & ⋯ & ⋯ & ⋯ \\ 1 & 2.469 & 98.631 & 98.942 \\ 1 & 2.472 & 1.000 & 2.000 \\ 1 & 2.473 & 1.058 & 2.009 \\ ⋯ & ⋯ & ⋯ & ⋯ \\ 1 & 2.493 & 1.331 & 2.146\end{matrix} ] F = [ \begin{matrix}0 & 0 & 0 & 0 \\ 0 & 0 & 0 & 0 \\ ⋯ & ⋯ & ⋯ & ⋯ \\ 0 & 0 & 0 & 0 \\ 0 & 0 & 0 & 1 \\ 0 & 0 & 0 & 1 \\ ⋯ & ⋯ & ⋯ & ⋯ \\ 0 & 0 & 0 & 1 \\ 0 & 0 & 1 & 0 \\ 0 & 0 & 1 & 0 \\ ⋯ & ⋯ & ⋯ & ⋯ \\ 0 & 0 & 1 & 0 \\ 1 & 0 & 0 & 0 \\ 1 & 0 & 0 & 0 \\ ⋯ & ⋯ & ⋯ & ⋯ \\ 1 & 0 & 0 & 0 \\ 0 & 1 & 0 & 0 \\ 0 & 1 & 0 & 0 \\ ⋯ & ⋯ & ⋯ & ⋯ \\ 0 & 1 & 0 & 0\end{matrix} ]$$

Using Equation 2, an A matrix can be generated as

$$A = [ \begin{matrix}- 11.5781 & - 8.0361 & - 6.2662 & 10.2279 \\ 4.6013 & 3.6034 & 2.5365 & - 4.0947 \\ - 0.0378 & 0.0373 & 0.1018 & - 0.0197 \\ 0.0475 & 0.0267 & - 0.1026 & 0.0213 \end{matrix} ]$$

Then, during operation of the process system 300, Equation 3 can be used to generate fault observation vectors using values of the process variables x₁, x₂, and x₃ and the matrix A. For example, if x₁=2.5, x₂=62, and x₃=52, this would result in a fault observation vector:

\hat{F}=[0.0503 0.0448 1.0494 −0.1237]

If a threshold of 0.8, for example, is used to determine if a component of the fault observation vector is significantly close to 1, the fault observation vector indicates that only fault F₃ is occurring.

Similarly, if x₁=2.5, x₂=3, and x₃=4, this would result in a fault observation vector:

\vec{F}=[0.0016 0.9670 −0.0300 0.0174]

If a threshold of 0.8, for example, is used to determine if a component of the fault observation vector is significantly close to 1, the fault observation vector indicates that only fault F₂ is occurring. As another example, if x₁=2.4, x₂=57, and x₃=55, this would result in a fault observation vector:

\hat{F}=[−0.0786 −0.0489 −0.0211 0.4483]

If a threshold of 0.8, for example, is used to determine if a component of the fault observation vector is significantly close to 1, this may indicate that none of the faults are occurring.

Process Variables

The process variables used to generate the matrix A and to generate fault observation vectors may be of a variety of types. For example, a process variable may be a signal generated by a device in the process plant such as a sensor, a valve, a controller, etc. Additionally, a process variable may be a signal generated by a device and that has been further processed. For example, an SPM block may receive a signal generated by a device and may then generate process variable that is a statistical signal such as a mean, a standard deviation, a root mean square, a skewness signal, a kurtosis signal, a maximum, a minimum, a range, etc. Similarly, a process variable may be signal generated by a device that is then filtered, for example, by a low pass filter, a band pass filter, a high pass filter, etc. Also, a process variable may be a signal to which a time delay is applied. Additionally, a process variable may be some linear or non-linear transformation of a signal generated by a device. Possible transformations include polynomial functions, trigonometric functions, exponential functions, logarithmic functions, splines, Fourier transforms, etc. Further, a process variable may be a signal calculated based on other process variables, such as signals generated by devices. As just one example, a process variable associated with a heat exchanger could include an overall heat transfer coefficient calculated based on a plurality of measurement signals. Of course, a process variable may have been processed by some combination of the above. As just one example a process variable could be a standard deviation signal that has been filtered by a high pass filter.

Examples of Implementing AOD Systems in One or More Process Plant Devices

As described previously, AOD systems such as those described herein, may be implemented in a variety of devices within a process plant. FIG. 8 is a block diagram showing one possible way in which an AOD system may be implemented in a process plant. In FIG. 8, a Fieldbus system 900 includes a flow transmitter 904 and a temperature transmitter 908 on a same Fieldbus segment 912. The flow transmitter 904 may implement an analog input function block 914 and an SPM block 916. Additionally, the flow transmitter 904 may implement an abnormal operation detection function block 918. The function block 918 may include a coefficient matrix generator that functions in a manner similar to that described above with respect to any of FIGS. 3, 4, and 5. Additionally, the function block 918 may include a fault observation vector generator that functions in a manner similar to that described above with respect to any of FIGS. 3, 4, and 6. Also, the function block 918 may include a fault detector that functions in a manner similar to that described above with respect to any of FIGS. 3, 4, and 6.

In operation, the analog input function block 914 may provide a process variable signal to the SPM block 916. In turn, the SPM block 916 may generate one or more statistical signals based on the process variable signal, and may provide the statistical signals to the abnormal operation detection function block 918. Similarly, the analog input function block 922 may provide a process variable signal to the SPM block 924. In turn, the SPM block 924 may generate one or more statistical signals based on the process variable signal, and may provide the statistical signals to the abnormal operation detection function block 918 via the Fieldbus segment 912.

In another implementation, the SPM blocks 916 and 924 may be incorporated within the abnormal operation detection function block 918. In this implementation, the analog input function block 914 may provide its process variable signal to the abnormal operation detection function block 918. Similarly, the analog input function block 922 may provide its process variable signal to the abnormal operation detection function block 918 via the Fieldbus segment 912. Of course, as described above, SPM blocks may not always be utilized in connection with abnormal operation detection function block 918, and thus may be omitted in some implementations.

As is known, some field devices are capable of making sensing of two or more process variables. Such a field device may be capable of implementing all of blocks 914, 916, 918, 922, and 924.

In another implementation, an AOD system may be implemented as a plurality of function blocks. In such an implementation, portions of the AOD system may be implemented on different devices in the process plant. As just one example, a coefficient matrix generator may be implemented by a workstation, a first field device, a first controller, etc., and a fault observation vector generator and a fault detector may be implemented by a second field device, a second controller, etc. For instance, a workstation may implement the coefficient matrix generator and one or more field devices may implement the fault observation vector generator and the fault detector. In this example, coefficient matrices generated by the workstation may be transmitted to one or more field devices in the process plant via one or more networks.

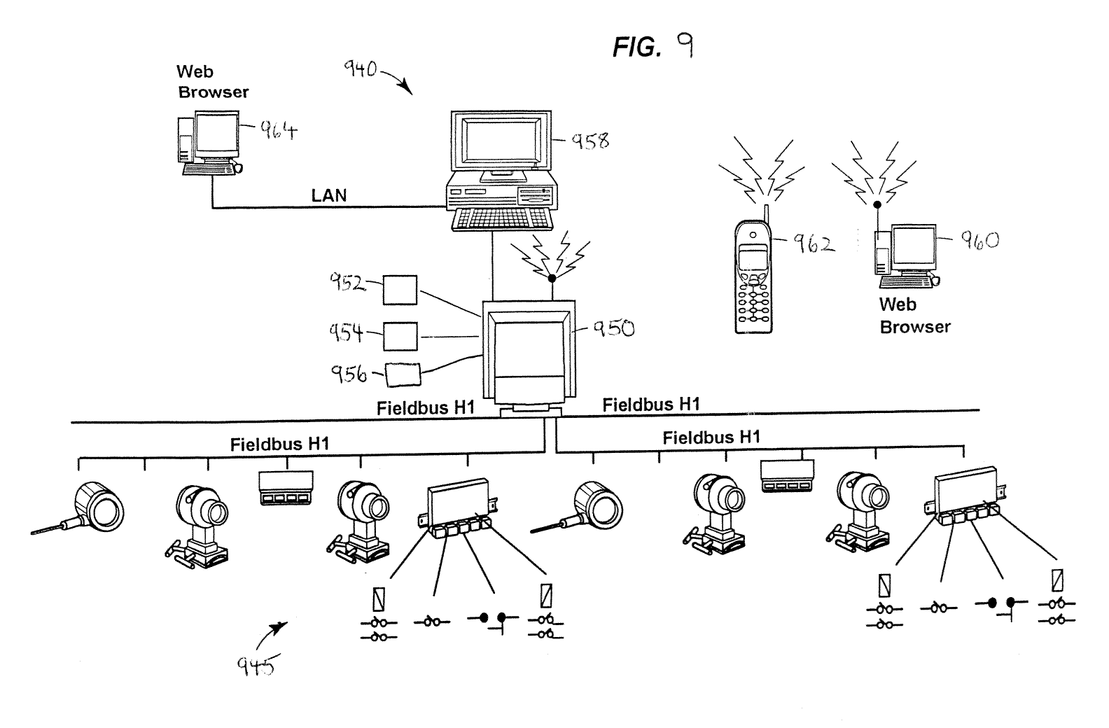

FIG. 9 illustrates another manner of implementing AOD systems in a process plant. In the system 940 of FIG. 9, some or all of the abnormal situation prevention application 35, the configuration application 38, and/or the alert/alarm application 43 may be stored in a device other than a host workstation or personal computer. The example system 940 of FIG. 9 includes a set of field devices 945 (illustrated as Fieldbus field devices, but they could be other types of devices as well) connected to an interface device 950, which may be, for example, the Rosemount 3420 device. In this case, the interface device 950, which is not a personal computer, may include some or all of the functionality of the abnormal situation prevention system 35 described above. In particular, the interface device 950 may include a server application 952 to receive and organize data delivered from the field devices 945 (which may be various different types of field devices). If desired, this server application 952 may include an OPC server. The configuration application 38 (or a portion of it) may also be stored in a memory of, and executed on a processor of, the interface device 950 to allow configuration of AOD blocks, SPM blocks, detection logic, etc., as described above. Similarly, the simulation application 44 (or a portion of it) may also be stored in the memory of, and executed on the processor of, the interface device 950 to generate simulated process variable for use in generating coefficient matrices, as described above.

Additionally, the interface device 950 may include one or more SPM blocks 954 therein to collect process variable data directly from one or more of the field devices (such as field devices which do not include SPM blocks or functionality) and to generate SPM parameters, as discussed above. Further, the interface device 950 may include one or more AOD blocks 956 therein to receive the SPM parameters and/or process variable data from field devices and to generate indicators of deviation, as discussed above. In this manner, the SPM blocks 954 and/or the AOD blocks 956 stored in and executed in the interface device 950 are able to compensate for the lack of SPM blocks and/or AOD blocks within certain ones of the field devices 945 and may be used to provide SPM data for field devices which do not themselves support SPM blocks or SPM functionality and/or AOD blocks or AOD functionality. Also, because the interface device 950 may typically have more memory and more processing power than a field device, implementing SPM blocks and/or AOD blocks in the interface device 950 may permit more complex AOD analysis to be performed.

The interface device 950 may communicate with other devices such as a host workstation 958 via a hardwired connection, such as a 2-wire, a 3-wire, a 4-wire, etc. connection, to provide SPM data, or data developed therefrom, such as alerts, data plots, etc. to those devices for viewing by a user. Additionally, as illustrated in FIG. 9, the interface device 950 may be connected via one or more wireless communication connections to a web browser 960 and to a handheld computing device 962, such as a telephone, a personal data assistant (PDA), a laptop computer, etc. In this example, an application may be stored in and executed in other devices, such as the host workstation 958, in the web browser 960 or in the handheld computing device 962 and these applications may communicate with the interface device 950 to obtain data for the application. If desired, the devices 958, 960 and 962 may include the configuration application 38 to enable a user to configure AOD blocks and/or SPM blocks implemented in the interface device 950. Similarly, the devices 958, 960 and 962 may include the simulation application 44 to enable generation of simulated process variable data for use in generating coefficient matrices. Likewise, as illustrated in FIG. 9, the data from the interface device 950 may be accessed indirectly from the host 958 by a web browser 964 and provided to other users via any desired web connection. Of course, the interface device 950 may include a web server therein and may communicate with any other device, such as the devices 958, 960, 962, and 964 using any desired protocol, such as OPC, Modbus, Ethernet, HTML, XML, etc.

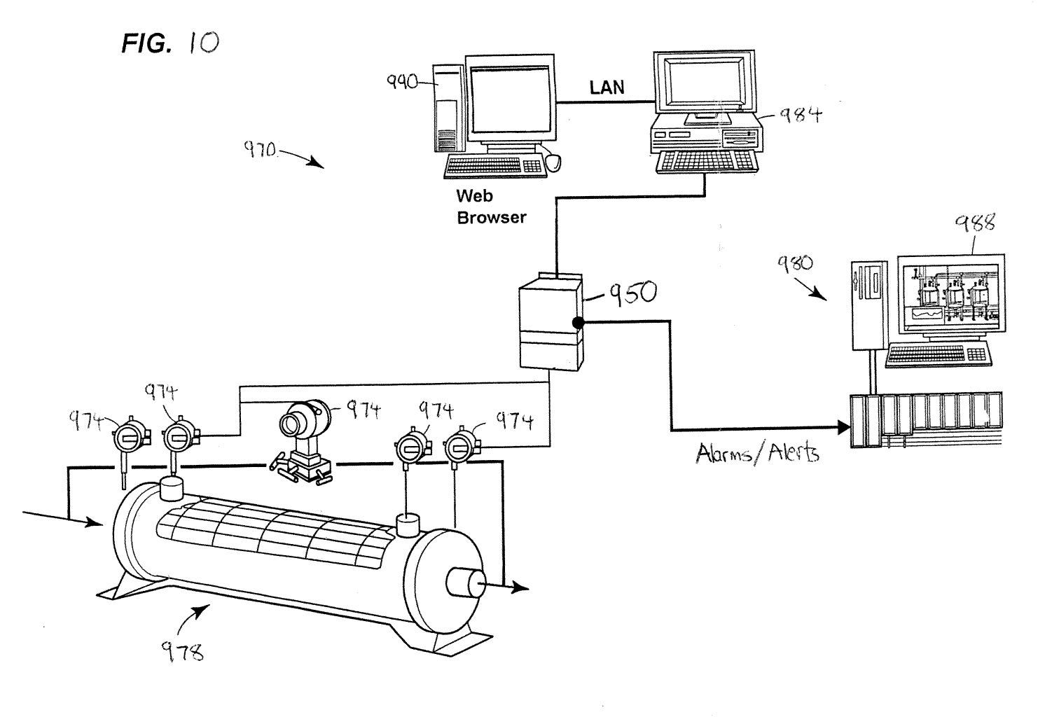

FIG. 10 illustrates a further process plant system 970 in which an interface device 950, which may be similar to or the same as that of FIG. 9, is connected between a set of field devices 974 (forming part of a heat exchanger 978) and a process controller system 980. Here, the interface device 950, which may include all of the applications and functionality of the device 950 of FIG. 9, may provide data for viewing to a host 984, and may provide alerts or alarms generated by AOD systems or other systems to the controller system 980. The controller system 980 may integrate these alerts or alarms with other controller type alerts and alarms for viewing by, for example, a control operator at an operator workstation 988. Of course, if desired, the host workstation 984 may include any desired viewing application to view the data collected in and provided by the interface device 950 in any desired manner, including any of those discussed herein. Likewise, this data may be made available for viewing by other users via a web browser 990. Thus, as will be understood, the various applications discussed herein as being associated with the abnormal situation prevention system 35, the SPM blocks (if used), and the AOD systems may be distributed in different devices. For instance, data (such as SPM data) may be collected in one device, such as a field device 974, and sent to another device, such as in the interface device 950, that implements an AOD system. Alerts, alarms, or other indicators generated by the AOD system may be sent to yet another device, such as the workstation 988, for presentation to a user. Likewise, configuration information may be input via a user interface device, such as a host, a web browser, a PDA, etc. and sent to a different device, such as the interface device 950, for configuring an AOD system.

As another example, an AOD system may be implemented in a workstation. Referring to FIGS. 9 and 10, the workstation 958 or the workstation 984 could receive process variable data from the interface device 950. The workstation 958 or the workstation 984 could implement an AOD system that operates on the received process variable data to generate indications of faults, for example. Fault indication data may be made available for viewing by other users via the web browser 964 or the web browser 990.

One of ordinary skill in the art will recognize that the example systems and methods described above may be modified in various ways. For example, blocks may be omitted, reordered, or combined, additional blocks may be added, etc. The AOD systems, fault detectors, logic blocks, system blocks, method blocks, etc., described herein may be implemented using any combination of hardware, firmware, and software. Thus, systems and techniques described herein may be implemented in a standard multi-purpose processor or using specifically designed hardware or firmware as desired. When implemented in software, the software may be stored in any computer readable memory such as on a magnetic disk, a laser disk, or other storage medium, in a RAM or ROM or flash memory of a computer, processor, I/O device, field device, interface device, etc. Likewise, the software may be delivered to a user or a process control system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software may be delivered to a user or a process control system via a communication channel such as a telephone line, the Internet, etc. (which are viewed as being the same as or interchangeable with providing such software via a transportable storage medium).

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method for facilitating detection of abnormal operation of a process in a process plant, comprising:
receiving first data corresponding to a plurality of process variables of a process plant;
using the first data and a coefficient matrix to generate a fault observation vector; and
determining whether there is abnormal operation of the process based on the fault observation vector.

2. A method according to claim 1, further comprising creating a process variable vector using the received first data;
wherein using the first data and the coefficient matrix to generate a fault observation vector comprises multiplying the process variable vector and the coefficient matrix.

3. A method according to claim 2, further comprising creating a process variable matrix using the received first data, the process variable matrix including the process variable vector;
wherein using the first data and the coefficient matrix to generate a fault observation vector comprises multiplying the process variable matrix and the coefficient matrix to generate a fault observation matrix including the fault observation vector.

4. A method according to claim 1, wherein determining whether there is abnormal operation of the process comprises determining whether there are one or more faults of a plurality of faults based on the fault observation vector.

5. A method according to claim 4, wherein determining whether there are one or more faults comprises comparing components of the fault observation vector to a threshold.

6. A method according to claim 5, further comprising generating an indicator of one fault from the plurality of faults if a component of the fault observation vector, corresponding to the one fault, exceeds a threshold.

7. A method according to claim 1, wherein determining whether there is abnormal operation of the process comprises providing components of the fault observation vector to at least one of an expert system, a neural network system, or a fuzzy logic system.

8. A method according to claim 1, further comprising:
receiving second data corresponding to the plurality of process variables, the second data corresponding to the occurrence of a plurality of faults;
generating the coefficient matrix using the second data.

9. A method according to claim 8, further comprising:
receiving third data corresponding to the plurality of process variables, the third data corresponding to the nonoccurrence of any faults of the plurality of faults;
wherein generating the coefficient matrix comprises generating the coefficient matrix using the third data.

10. A tangible medium storing machine readable instructions, the machine readable instructions capable of causing one or more machines to:
receive data corresponding to a plurality of process variables of a process plant;
use the first data and a coefficient matrix to generate a fault observation vector; and
determine whether there is abnormal operation of the process based on the fault observation vector.

11. A system for facilitating detection of abnormal operation of a process in a process plant, comprising:
a fault observation vector generator coupled to receive a coefficient matrix and process variable data associated with the process plant; and
an abnormal operation detection system, coupled to the fault observation vector generator, to detect abnormal operation of the process plant based on a fault observation vector.

12. A system according to claim 11, wherein the abnormal operation detection system is configured to compare components of the fault observation vector to a threshold and to generate indicators of faults based on the comparison.

13. A system according to claim 11, wherein the abnormal operation detection system comprises at least one of an expert system, a neural network system, or a fuzzy logic system.

14. A system according to claim 11, further comprising a coefficient matrix generator coupled to the fault observation vector generator, the coefficient matrix generator configured to generate the coefficient matrix based on process variable data corresponding to occurrences of faults of a plurality of faults.

15. A system according to claim 14, wherein the coefficient matrix generator is configured to generate the coefficient matrix further based on process variable data corresponding to non-occurrences of any of the faults of the plurality of faults.

16. A system according to claim 14, wherein the coefficient matrix generator is implemented in a first device of the process plant, wherein the fault observation vector generator is implemented in a second device of the process plant, and wherein the abnormal operation detection system is implemented in at least a third device of the process plant.

17. A system according to claim 14, wherein the coefficient matrix generator and the fault observation vector generator are implemented in a first device of the process plant, and wherein the abnormal operation detection system is implemented in at least a second device of the process plant.

18. A system according to claim 14, wherein the coefficient matrix generator, the fault observation vector generator, and the abnormal operation detection system are implemented in a single device of the process plant.

19. A method for configuring an abnormal operation detection system for a process plant, comprising:
receiving first process variable data corresponding to the occurrences of faults of a plurality of faults of a process system in the process plant;
generating a process variable data matrix based on the first process variable data;
generating a fault matrix corresponding to the process variable data matrix; and
generating a coefficient matrix using the process variable data matrix and the fault matrix, the coefficient matrix to be used by an abnormal operation detection system to generate indicators of faults based on process variable data received by the abnormal operation detection system.

20. A method according to claim 19, further comprising receiving second process variable data corresponding to the non-occurrence of any faults of the plurality of faults;
wherein generating the process variable data matrix comprises generating the process variable data matrix further based on the second process variable data.

21. A method according to claim 20, wherein the first process variable data includes process variable data corresponding to individual occurrences of each fault of the plurality of faults.

22. A method according to claim 19, wherein generating the process variable data matrix comprises including bias terms in the process variable data matrix.

23. A method according to claim 19, wherein generating the coefficient matrix comprises generating the coefficient matrix according to a regression technique.

24. A method according to claim 23, wherein generating the coefficient matrix comprises generating the coefficient matrix according to the equation:
A=(X^{T}X)⁻¹X^{T}F;
wherein A is the coefficient matrix, X is the process variable data matrix, and F is the fault matrix.

25. A method according to claim 23, wherein each row of the process variable data matrix X corresponds to different set of the first process variable data;
wherein each column of the fault matrix F corresponds to a different fault from the plurality of faults;
wherein each row of the fault matrix F corresponds to a different row of the process variable data matrix;
wherein generating the fault matrix comprises, for each row of the fault matrix F, inserting a non-zero value in the row at a column that corresponds to the fault, if any, associated with the corresponding row of the process variable data matrix X and inserting zero values in the remaining columns.

26. A method according to claim 25, wherein the non-zero value is one.

27. A method according to claim 23, wherein generating the process variable data matrix comprises creating a column having a bias value in each row.

28. A method according to claim 27, wherein the bias value is one.

29. A method according to claim 23, wherein generating the coefficient matrix comprises generating the coefficient matrix according to at least one of an ordinary least squares (OLS) technique, a multiple linear regression (MLR) technique, a partial least squares (PLS) technique, a principal component analysis (PCA) technique, a principal component regression (PCR) technique, a ridge regression (RR) technique, a variable subset selection (VSS) technique, or a support vector machines (SVM) technique.

30. A method according to claim 23, wherein generating the coefficient matrix comprises generating the coefficient matrix according to a non-linear regression technique.

31. A method according to claim 30, wherein the non-linear regression technique comprises at least one of using higher-order powers of the process variables, using cross-terms of the process variables, using nonlinear functions of the process variables, or a neural network technique.

32. A method according to claim 23, wherein generating the coefficient matrix comprises generating the coefficient matrix according to a regression technique utilizing time-delayed values of elements of the process variable data matrix.

33. A method according to claim 19, further comprising transmitting the coefficient matrix over a communication link in the process plant.

34. A method according to claim 33, wherein transmitting the coefficient matrix comprises transmitting the coefficient matrix to a field device over a bus.

35. A tangible medium storing machine readable instructions, the machine readable instructions capable of causing one or more machines to:
receive process variable data corresponding to the occurrences of faults of a plurality of faults of a process system in the process plant;
generate a process variable data matrix based on the process variable data;
generate a fault matrix corresponding to the process variable data matrix; and
generate a coefficient matrix using the process variable data matrix and the fault matrix, the coefficient matrix to be used by an abnormal operation detection system to generate indicators of faults based on process variable data received by the abnormal operation detection system.

36. A system for facilitating detection of abnormal operation of a process in a process plant, comprising:
at least one computer readable medium;
at least one processor coupled to the at least one computer readable medium, the processor configured according to executable instructions stored on the at least one computer readable medium to:
receive process variable data corresponding to the occurrences of faults of a plurality of faults of a process system in the process plant;
generate a process variable data matrix based on the process variable data;
generate a fault matrix corresponding to the process variable data matrix; and
generate a coefficient matrix using the process variable data matrix and the fault matrix, the coefficient matrix to be used by an abnormal operation detection system to generate indicators of faults based on process variable data received by the abnormal operation detection system.
